(19) United States
(12) Patent Application Publication
(10) Pub. No.: US 2012/0096980 A1
(43) Pub. Date: Apr. 26, 2012

(54) STEERING WHEEL FOR A VEHICLE AND VEHICLE

(75) Inventors: Thomas Schramm, Mainz (DE); Ralf Rathmacher, Schmitten im Taunus (DE); Michael Schiebahn, Wesseling (DE)

(73) Assignee: GM GLOBAL TECHNOLOGY OPERATIONS LLC, Detroit, MI (US)

(21) Appl. No.: 13/278,268

(22) Filed: Oct. 21, 2011

(30) Foreign Application Priority Data
Oct. 21, 2010 (DE) 102010049087.3

(51) Int. Cl. B62D 1/04; G05G 1/10

(52) U.S. Cl. 74/552

(57) ABSTRACT

A steering wheel is provided for a vehicle with a middle section. The middle section exhibits a front side facing the driver and a rear side facing away from the driver. An input device with at least one scroll wheel is arranged in the region of the middle section. At least one first region of the scroll wheel on the front side of the middle section and a second region of the scroll wheel on the rear side of the middle section are exposed for activation purposes.

### CROSS-REFERENCE TO RELATED APPLICATION

This application claims priority to German Patent Application No. 102010049082.2, filed Oct. 21, 2010, which is incorporated herein by reference in its entirety.

### TECHNICAL FIELD

The technical field relates to a steering wheel for a vehicle, with a ring and middle section, and an input device arranged in the steering wheel. It further relates to a vehicle with such a steering wheel.

### BACKGROUND

The variety of functions in modern motor vehicles necessitates input devices that are ergonomically arranged and operable, with which a driver can comfortably and safety actuate the gear shift, an air conditioner or an infotainment system in the vehicle, for example, even while driving.

Known from U.S. Pat. No. 6,819,990 B2 is an input device with touchpad situated in the area of the steering wheel, which can be used, for example, to operate a navigation system or air conditioner. In such input devices, touchpad operation is not particularly intuitive. Rather, the driver must take one hand from the steering wheel and look at the touchpad. As a result, the attention of the driver is from time to time diverted from the road, as in the case of a conventional arrangement of controls in the middle of the cockpit.

At least one object is to create an input device that is comfortable for the driver to operate, the operation of which also distracts the driver as little as possible from road traffic. In addition, other objects, desirable features and characteristics will become apparent from the subsequent summary and detailed description, and the appended claims, taken in conjunction with the accompanying drawings and this background.

### SUMMARY

A steering wheel is provided for a vehicle with a ring and middle section. The middle section exhibits a front side facing the driver, and a rear side facing away from the driver. Situated in the area of the middle section is an input device with at least one scroll wheel. At least a first area of the scroll wheel on the front side of the middle section and a second area of the scroll wheel on the rear side of the middle section are exposed for activation purposes. Scroll wheel activation is understood here and below as making an entry, i.e., for example moving a cursor over a screen or through a menu, or making a selection from the menu.

The middle section of a steering wheel typically has at least a regionally rounded cross section. The front side of the middle section is understood here and below as an area of the middle section that faces the driver and essentially lies in a principle plane of the steering wheel, even if it is not planar. The rear side of the middle section is understood as an area of the middle section that faces away from the driver and lies opposite the front side.

The scroll wheel (English: jog dial) is understood here and below as an input device in the form of a wheel that can be turned with the finger. The wheel can be turned in both directions without a limit stop, while a rotary pulse generator, for example, detects a change in position of the scroll wheel.

In one embodiment, the input device exhibits an optical rotary pulse generator to acquire a change in position of the scroll wheel. The scroll wheel exhibits a rotational axis around which it is rotatably mounted. In one embodiment, the scroll wheel can further be activated by pressure perpendicular to its rotational axis. In this embodiment, the scroll wheel hence has several options for activation, specifically in addition to being turned around its rotational axis, it can be pressed perpendicularly to its rotational axis, e.g., backwards, forwards, up or down. The scroll wheel is shifted during this activation.

In one embodiment, the scroll wheel can further be activated by laterally pressing it parallel to the direction of its rotational axis. This activation causes the scroll wheel to tilt, as a result of which its rotational axis is also tilted in relation to a starting position. The input device advantageously exhibits a capacitive switch to detect a change in position of the scroll wheel.

The scroll wheel can be mounted on a spherical surface, wherein a spherical surfaced is very generally understood as a convex surface that is curved in two directions. This type of mounting enables the scroll wheel to “float” on the bearing, and hence gives it a wide range of motion in several directions.

The scroll wheel can here be resiliently mounted on the spherical surface, so that an increasing resistance is offered to the user during activation before a limit stop is reached. The scroll wheel is at least partially exposed on both the front side and rear side of the steering wheel. Therefore, a relatively large scroll wheel with a diameter d of approximately 3 cm≦d≦approximately 6 cm can be used. In one embodiment, the entire circumference of the scroll wheel is exposed for activation purposes. In this embodiment, the scroll wheel can be arranged in particular in such a way as to completely envelop a spoke of the steering wheel.

The advantage to the steering wheel is that the scroll wheel provides an input device that is especially intuitive and ergonomic to use. The scroll wheel is easy to operate, and already familiar to many drivers from other technical devices. Since the scroll wheel can be exposed on both the front side and rear side of the steering wheel for activation purposes and arranged within reach of a driver, it can be conveniently operated with the thumb and/or forefinger, without the driver having to take his or her hand from the steering wheel to do so. The position of the scroll wheel is easy to feel out, so that the driver need not look at it during activation, but can rather keep his or her eyes on the road.

A vehicle is provided with such a steering wheel. In one embodiment, at least one output device is connected with the input device. The output device is designed as a display and/or a voice output. In this embodiment, the driver can use this output device to obtain information, for example, about an optional selection from a menu or an already selected value.

For example, this can take place by way of a display indication or voice output, wherein both options can also be combined with each other or with other possibilities, so as to combine the respective advantages, e.g., providing various on-screen display options and giving the driver information without distracting his or her attention from the road during voice output.

The output device can here be arranged in the steering wheel and/or in an instrument cluster and/or in another screen of the vehicle.

The scroll wheel arranged on the steering wheel makes it possible to operate various devices in the vehicle. An incremental switch like the scroll wheel can basically be used anywhere that the objective is to navigate through a sequence of values and make a selection from this sequence.

In one embodiment, the vehicle exhibits an automatic transmission, which can be operated from the scroll wheel. A gear can here be set or selected by turning the scroll wheel, and the selection can be confirmed by pressing the scroll wheel.

In one embodiment, the vehicle exhibits an infotainment system, which can be operated from the scroll wheel. In particular, the infotainment system can encompass an audio/video system and/or a navigation system and/or a telecommunication system in the vehicle.

In one embodiment, the vehicle exhibits an air conditioner, which can be operated from the scroll wheel.

### BRIEF DESCRIPTION OF THE DRAWINGS

The present invention will hereinafter be described in conjunction with the following drawing figures, wherein like numerals denote like elements, and:

FIG. 1 shows a diagrammatic view of a steering wheel with a scroll wheel according to a first embodiment;

FIG. 2 shows a diagrammatic view of a cross section through the steering wheel according to FIG. 1;

FIG. 3 shows diagrammatic cross sections through the steering wheel according to FIG. 1 during an activation;

FIG. 4 shows diagrammatic cross sections through the steering wheel according to FIG. 1 during an activation;

FIG. 5 shows a diagrammatic view of a steering wheel with a scroll wheel according to a second embodiment;

FIG. 6 shows a diagrammatic cross section through the steering wheel according to FIG. 5; and

FIG. 7 shows diagrammatic cross sections through the steering wheel according to FIG. 5 during an activation.

### DETAILED DESCRIPTION

The following detailed description is merely exemplary in nature and is not intended to limit application and uses. Furthermore, there is no intention to be bound by any theory presented in the preceding background or summary or the following detailed description.

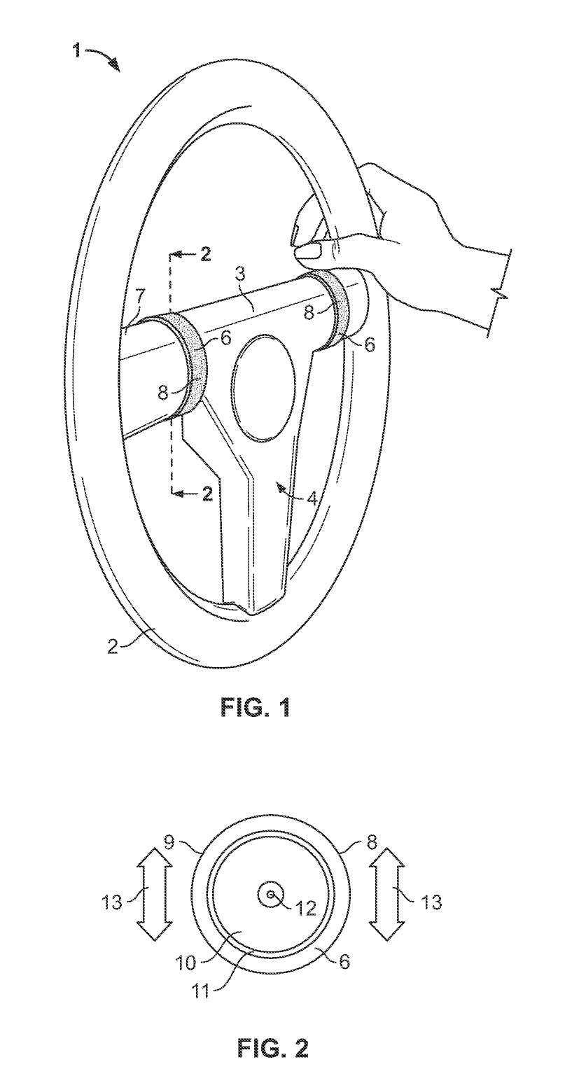

FIG. 1 shows a first embodiment of the steering wheel 1 of a vehicle with an input device. FIG. 2 shows the steering wheel 1 in cross section along the intersecting line A-A on FIG. 1. The steering wheel 1 encompasses a ring 2 and middle section 3 with spokes 7 and a front side 4 and rear side 5. The input device in this embodiment encompasses two scroll wheels 6, which are situated in the right or left half of the middle section 3 in such a way as to envelop spokes 7. Consequently, the scroll wheels in this embodiment are exposed for activation purposes not only in a first region 8 on the front side 4 of the middle section 3 and in a second region 9 on the rear side 5 of the middle section 3, but also over their entire periphery. The scroll wheels 6 are situated on the middle section 3 in such a way as to lie within reach of the driver. This means that the driver can reach them with his or her thumb and/or forefinger without taking his or her hand off the steering wheel 1.

As may be gleaned especially well from FIG. 2, each scroll wheel 6 can be turned around the rotational axis 12, which in a resting position of the scroll wheel 6 essentially corresponds to the axis of the spoke 7. It envelops an inner region 10 of the middle section 3, in which is arranged a rotary pulse generator (not shown) for determining changes in position of the scroll wheel 6. Situated between the scroll wheel 6 and inner region 10 is a bearing 11, which has a surface cut out of a spherical surface, and resiliently holds the scroll wheel 6. For example, a user can activate the scroll wheel 6 with the thumb and forefinger, in particular turns it around the rotational axis 12 in the direction of the arrows 13. This type of activation is used in particular to scroll through a menu or chart.

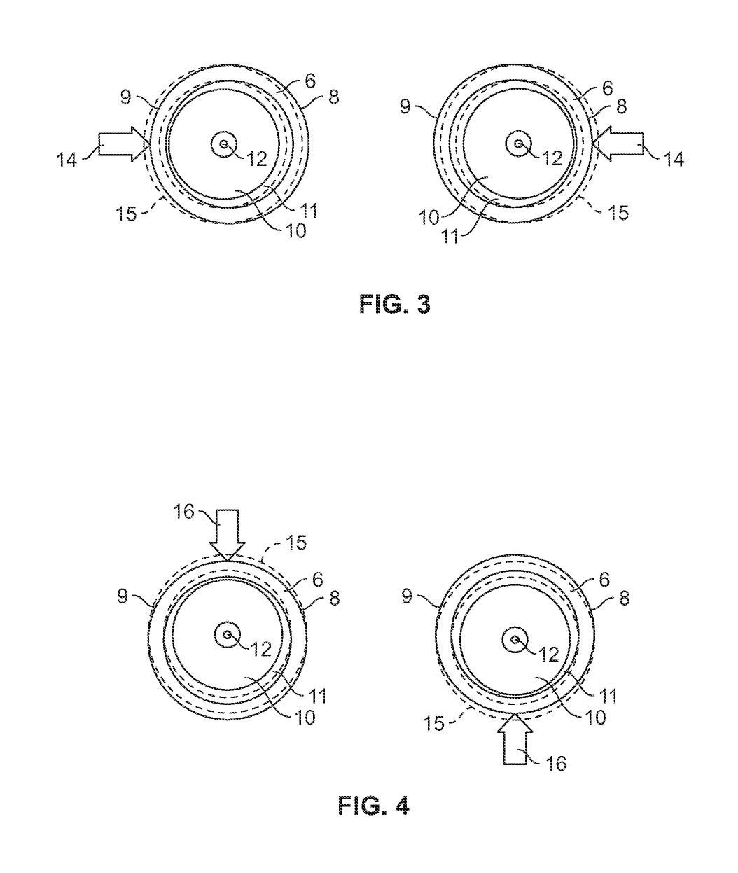

FIG. 3 and FIG. 4 show various additional ways of activating the scroll wheel 6. As depicted on FIG. 3, the scroll wheel 6 can also be activated by exerting pressure perpendicular to the rotational axis 12, in particular on the first region 8 or second region 9. This movement is indicated on FIG. 3 by the arrows 14. As a result, the scroll wheel 6 is shifted backward or forward, wherein its starting position is denoted by the dashed line 15. Provided for recording this change in position are corresponding sensors, in particular capacitive switches, which are activated by the pressure. For example, this type of activation confirms a selection from a menu, zooms in and out of a view, or shifts a gear up or down.

As shown on FIG. 4, the scroll wheel 6 can also be activated by pressure from above or below, as indicated by arrows 16. The scroll wheel 6 is shifted in this type of activation as well, specifically down or up. Corresponding sensors are also provided in the middle section to record this change in position. For example, this type of activation confirms a selection from the menu, zooms in and out of a view, or shifts a gear up or down. This activation can also be documented by software in such a way as to affect an incremental jump up or down in a menu.

Another type of activation not depicted involves an activation by exerting pressure parallel to the direction of the rotational axis 12, which tilts the scroll wheel 6 to the right or left from its perpendicular arrangement. In particular, this type of activation makes it possible to horizontally scroll through a menu. The advantage to the first embodiment is that it offers an especially wide variety of ways for activation due to the completely exposed scroll wheel 6.

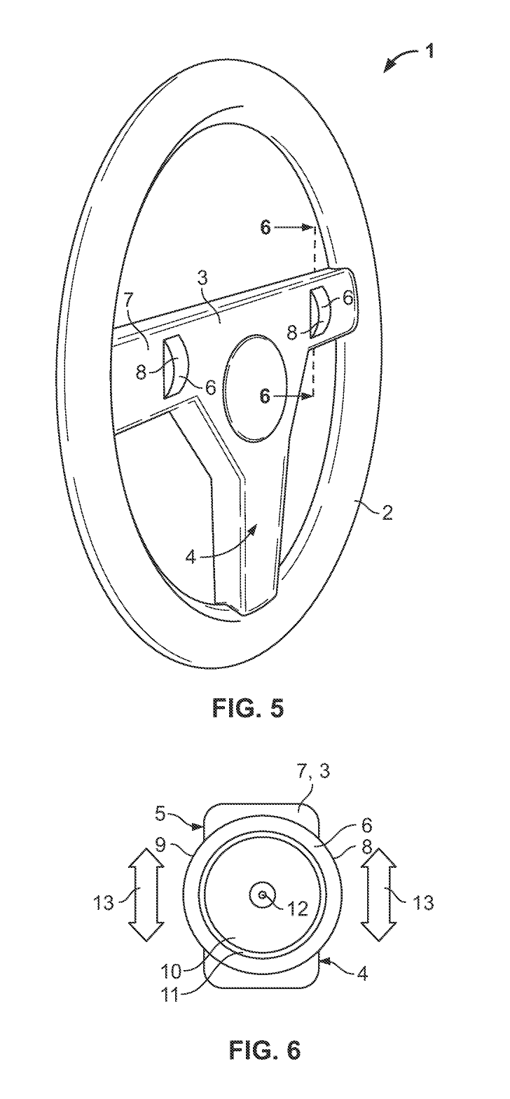

FIG. 5 shows a second embodiment of the steering wheel 1 of a vehicle with an input device. FIG. 6 shows the steering wheel 1 in cross section along intersecting line A-A on FIG. 5. The steering wheel 1 according to the second embodiment differs from that according to the first embodiment in that the two scroll wheels 6 are partially embedded in the spoke 7 of the middle section 3. In this embodiment, only a first region 8 on the front side 4 and a second region 9 on the rear side 5 of the steering wheel 1 are exposed for activation purposes.

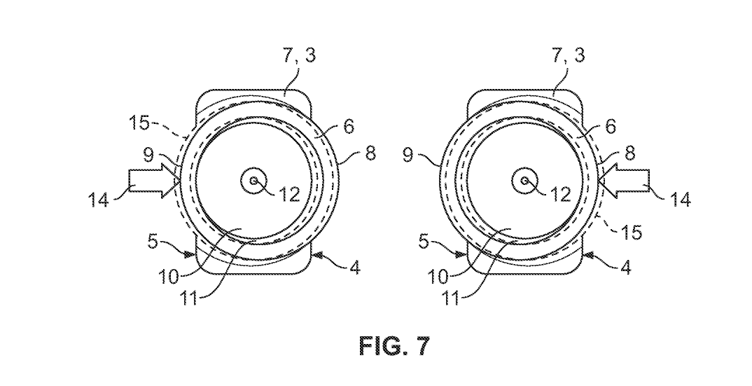

FIG. 6 illustrates the activation of the scroll wheel 6 by turning it around the rotational axis 12 in the direction of the arrows 13. The scroll wheel 6 according to the second embodiment further provides a second type of activation, which is depicted on FIG. 7. The scroll wheel 6 can here be moved backward or forward by pressing on the first region 8 or second region 9, and activated in this way.

Because it is partially embedded in the steering wheel 1, the scroll wheel 6 according to the second embodiment cannot be activated by pressing from above and below. However, as with the scroll wheel 6 according to the first embodiment, activation can also take place by exerting pressure parallel to the direction of the rotational axis 12, which tilts the scroll wheel 6 to the right or left from its perpendicular arrangement. The advantage to the second embodiment is that the partially embedded scroll wheels 6 make it especially robust and insusceptible to inadvertent activations.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A steering wheel for a vehicle, comprising:
a middle section having a front side facing a driver and a rear side facing away from the driver; and
an input device having a scroll wheel arranged in a region of the middle section,
wherein at least one first region of the scroll wheel on the front side of the middle section and a second region of the scroll wheel on the rear side of the middle section are exposed for activation purposes.

2. The steering wheel according to claim 1, wherein the input device comprises an optical rotary pulse generator to detect a change in position of the scroll wheel.

3. The steering wheel according to claim 1,
wherein the scroll wheel comprises a rotational axis around which the scroll wheel is rotatably mounted, and
wherein the scroll wheel are further configured to activate by pressure perpendicular to the rotational axis.

4. The steering wheel according to claim 1, wherein the scroll wheel is further configured to activate by laterally pressing the scroll wheel that is parallel to a direction of a rotational axis.

5. The steering wheel according to claim 3, wherein the input device is a capacitive switch that is configured to detect a change in position of the scroll wheel.

6. The steering wheel according to claim 1, wherein the scroll wheel is mounted on a spherical surface.

7. The steering wheel according to claim 6, wherein the scroll wheel is resiliently mounted on the spherical surface.

8. The steering wheel according to claim 1, wherein the scroll wheel comprises a diameter of approximately 3 cm≦d≦approximately 6 cm.

9. The steering wheel according to claim 1, wherein the scroll wheel is exposed on an entire circumference for activation purposes.

10. The steering wheel according to claim 1,
wherein at least one output device is connected with the input device, and
wherein the at least one output device is a display.

11. The steering wheel according to claim 10,
wherein the at least one output device is connected with the input device, and
wherein the at least one output device is a voice output.

12. The steering wheel according to claim 11, wherein the at least one output device is arranged in an instrument cluster.

13. The steering wheel according to claim 11, wherein the at least one output device is arranged in the steering wheel.

14. The steering wheel according to claim 11, wherein the at least one output device is arranged in in another screen.

15. The steering wheel according to claim 1, wherein the scroll wheel is configured to operate an automatic transmission

16. The steering wheel according to claim 1, wherein the scroll wheel is configured to operate an infotainment system.

17. The steering wheel according to claim 1, wherein the scroll wheel is configured to operates an air conditioner.
